(19) United States
(12) Patent Application Publication
(10) Pub. No.: US 2018/0328228 A1
(43) Pub. Date: Nov. 15, 2018

(54) TURBINE VANE WITH INNER CIRCUMFERENTIAL ANTI-ROTATION FEATURES

(71) Applicant: United Technologies Corporation, Farmington, CT (US)

(72) Inventors: Joseph F. Englehart, Gastonia, NC (US); Craig R. McGarrah, Southington, CT (US)

(21) Appl. No.: 15/919,832

(22) Filed: Mar. 13, 2018

Related U.S. Application Data
(60) Provisional application No. 62/505,279, filed on May 12, 2017.

(51) Int. Cl. F01D 25/28; F01D 9/04

(52) U.S. Cl. CPC F01D 25/28; F01D 9/041; F05D 2220/323; F05D 2240/55; F05D 2240/12

(57) ABSTRACT

A vane assembly includes an outer platform, an inner platform, and a vane. The inner platform has an inner flange that includes a first face, a second face disposed opposite the first face, a third face extending from the first face towards the second face, and a fourth face extending from the third face towards a tip of the inner flange. The third face and the fourth face at least partially define a first notch.

### CROSS-REFERENCE TO RELATED APPLICATIONS

This application claims the benefit of U.S. Provisional Patent Application Ser. No. 62/505,279 filed May 12, 2017, which is incorporated herein by reference in its entirety.

### BACKGROUND

Illustrative embodiments pertain to the art of turbomachinery, and specifically to turbine rotor components.

Gas turbine engines are rotary-type combustion turbine engines built around a power core made up of a compressor, combustor and turbine, arranged in flow series with an upstream inlet and downstream exhaust. The compressor compresses air from the inlet, which is mixed with fuel in the combustor and ignited to generate hot combustion gas. The turbine extracts energy from the expanding combustion gas, and drives the compressor via a common shaft. Energy is delivered in the form of rotational energy in the shaft, reactive thrust from the exhaust, or both.

Vane assemblies of the gas turbine engine may be cantilevered or simply supported within the gas turbine engine. The cantilevered arrangement contacts a support case via features on its outer platform only. The simply supported arrangement contacts a support case via features on both its outer platform and inner platform. The supports at the outer diameter may be subjected to loading that may not satisfy product requirements. Accordingly it is desirable to develop a vane assembly support arrangement to satisfy product requirements.

### BRIEF DESCRIPTION

Disclosed is a gas turbine engine that includes an outer support member, an inner support member, and a vane assembly. The inner support member is radially spaced apart from the outer support member. The vane assembly includes an outer platform, an inner platform, and a vane. The outer platform has a first outer flange that is operatively connected to the outer support member. The inner platform has an inner flange that includes a first face, a second face disposed opposite the first face, a third face extending from the first face towards the second face, and a fourth face extending from the third face towards a tip of the inner flange. The third face and the fourth face at least partially define a first notch. The vane extends between the outer platform and the inner platform.

In addition to one or more of the features described above, or as an alternative to any of the foregoing embodiments, the inner flange has a first side surface that extends between the first face, the third face, and the fourth face and the inner flange has a second side surface that is disposed opposite the first side surface and that extends between the first face, the third face, and the fourth face.

In addition to one or more of the features described above, or as an alternative to any of the foregoing embodiments, the second face engages the inner support member.

In addition to one or more of the features described above, or as an alternative to any of the foregoing embodiments, the first outer flange abuts the outer support member.

In addition to one or more of the features described above, or as an alternative to any of the foregoing embodiments, the gas turbine engine further includes a seal retainer that is operatively connected to the inner platform and engages the inner flange.

In addition to one or more of the features described above, or as an alternative to any of the foregoing embodiments, the seal retainer includes a seal body, a lug extending from the seal body and is at least partially received by the first notch, and a seal flange extending from the seal body and is disposed perpendicular to the seal body.

Also disclosed is a vane assembly for a gas turbine engine that includes an outer platform, an inner platform, a vane, and a seal retainer. The inner platform is disposed opposite the outer platform. The inner platform includes an inner flange that extends from the inner platform towards an inner support member. The inner flange has a first face and a second face disposed opposite the first face. The inner flange defines a first notch that extends from the first face towards the second face. The vane extends between the outer platform and the inner platform. The seal retainer has a seal body, a lug extending from the seal body that is at least partially received within the first notch, and a seal flange extending from the seal body and extending towards the inner platform.

In addition to one or more of the features described above, or as an alternative to any of the foregoing embodiments, the inner flange has a third face extending from the first face towards the second face, a fourth face extending from the third face towards a tip of the inner flange, a first side surface that extends between the first face, the third face, and the fourth face and the inner flange has a second side surface that is disposed opposite the first side surface and that extends between the first face, the third face, and the fourth face.

In addition to one or more of the features described above, or as an alternative to any of the foregoing embodiments, the first notch is defined by the third face, the fourth face, first side surface, and the second side surface of the inner flange.

In addition to one or more of the features described above, or as an alternative to any of the foregoing embodiments, the first notch is disposed proximate the tip of the inner flange.

In addition to one or more of the features described above, or as an alternative to any of the foregoing embodiments, the seal body is disposed on the inner support member and the seal flange is operatively connected to the inner support member.

In addition to one or more of the features described above, or as an alternative to any of the foregoing embodiments, the seal retainer has a seal mounting feature extending from the seal body and is disposed opposite the seal flange.

In addition to one or more of the features described above, or as an alternative to any of the foregoing embodiments, the seal mounting feature defines an opening that is arranged to receive a sealing member that engages the first face.

In addition to one or more of the features described above, or as an alternative to any of the foregoing embodiments, the lug engages the fourth face.

Further disclosed is a vane assembly that includes an inner platform, a vane, and a seal retainer. The inner platform is disposed opposite an outer platform and is provided with an inner flange. The inner flange has a first face, a second face disposed opposite the first face, a third face extending from the first face towards the second face, a fourth face extending from the third face towards a tip of the inner flange, a first side surface and a second side surface disposed opposite the first side surface, each extending between the first face, the third face, and the fourth face. The third face, the fourth face, the first side surface, and the second side surface define a first notch. The vane extends between the outer platform and the inner platform. The seal retainer has a seal body and a lug extending from the seal body and received by the first notch.

In addition to one or more of the features described above, or as an alternative to any of the foregoing embodiments, the seal retainer has a seal flange extending from the seal body that is operatively connected to an inner support member.

In addition to one or more of the features described above, or as an alternative to any of the foregoing embodiments, the seal flange extends from the seal body in a first direction.

In addition to one or more of the features described above, or as an alternative to any of the foregoing embodiments, the lug extends from seal body in a direction that is disposed transverse to the first direction.

### BRIEF DESCRIPTION OF THE DRAWINGS

The following descriptions should not be considered limiting in any way. With reference to the accompanying drawings, like elements are numbered alike:

FIG. 1 is a schematic of an illustrative gas turbine engine;

FIG. 2 is a partial side view of a portion of a turbine section of the gas turbine engine;

FIG. 3 is a partial side view of another portion of the turbine section;

FIG. 4 is a perspective view of a portion of a vane assembly of the turbine section; and

FIG. 5 is a partial perspective view of a seal retainer.

### DETAILED DESCRIPTION

A detailed description of one or more embodiments of the disclosed apparatus and method are presented herein by way of exemplification and not limitation with reference to the Figures.

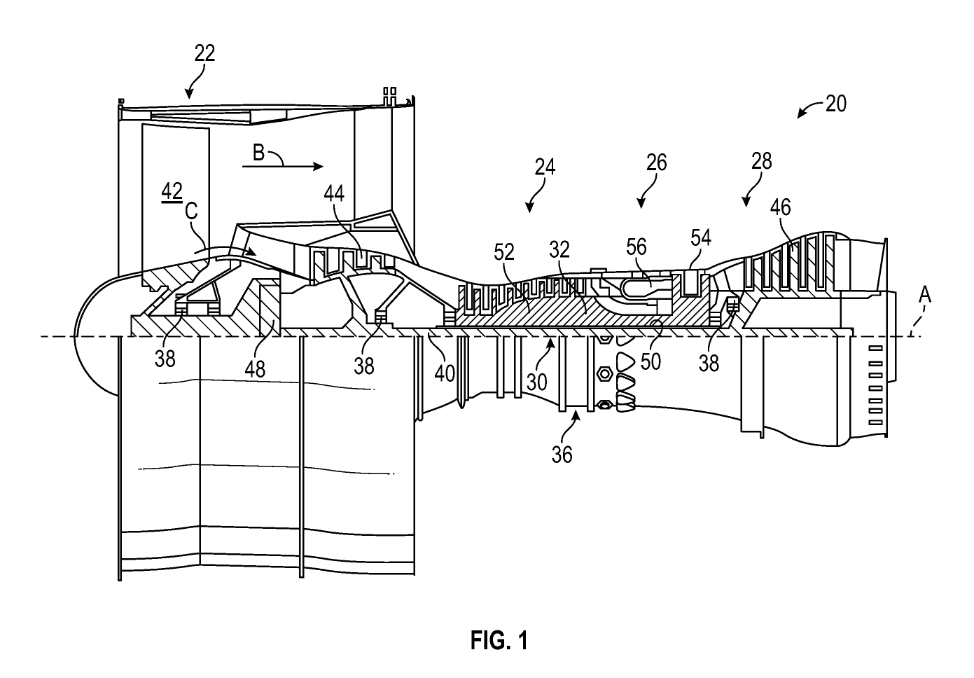

FIG. 1 schematically illustrates a gas turbine engine 20. The gas turbine engine 20 is disclosed herein as a two-spool turbofan that generally incorporates a fan section 22, a compressor section 24, a combustor section 26, and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The gas turbine engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54.

A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28.

The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The gas turbine engine 20 in one example is a high-bypass geared aircraft engine. In a further example, the gas turbine engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the gas turbine engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

Although the gas turbine engine 20 is depicted as a turbofan, it should be understood that the concepts described herein are not limited to use with the described configuration, as the teachings may be applied to other types of engines such as, but not limited to, turbojets, turboshafts, and three-spool (plus fan) turbofans wherein an intermediate spool includes an intermediate pressure compressor (“IPC”) between a low pressure compressor (“LPC”) and a high pressure compressor (“HPC”), and an intermediate pressure turbine (“IPT”) between the high pressure turbine (“HPT”) and the low pressure turbine (“LPT”).

As used herein, the term “radial” refers to direction that is disposed substantially transverse to the engine central longitudinal axis A. The radial direction extends perpendicularly from the engine central longitudinal axis A towards an outer circumferential location of the gas turbine engine 20. The term “axial” refers to a direction that is disposed substantially parallel to the engine central longitudinal axis A. The term “tangential” refers to a direction that is disposed substantially transverse to both the radial direction and the axial direction with respect to the engine central longitudinal axis A.

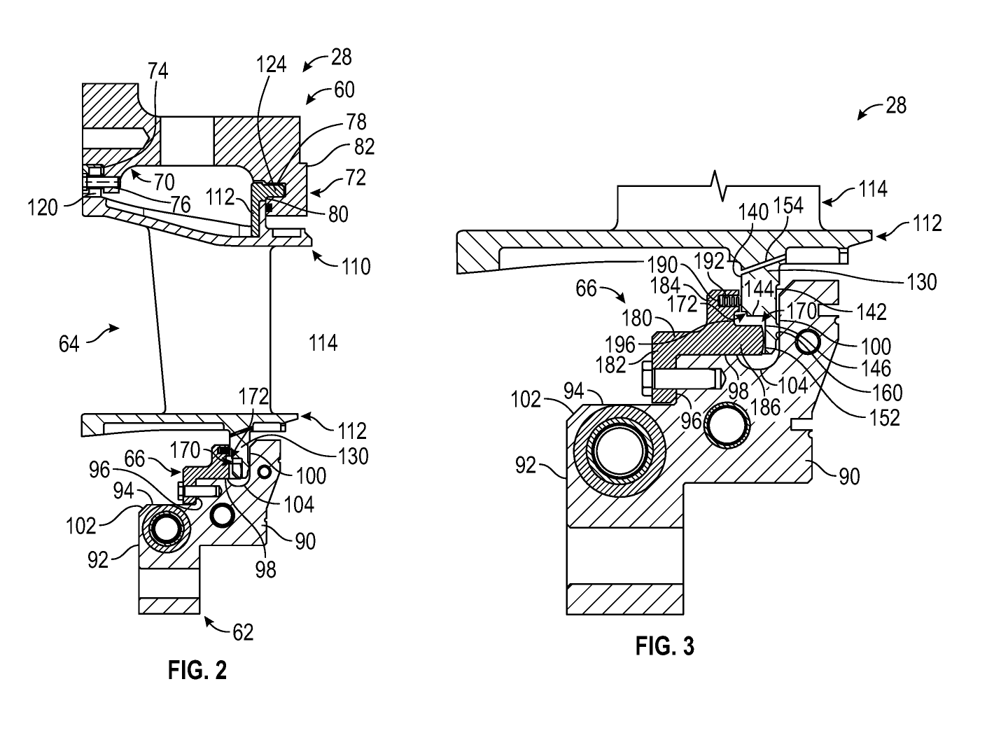

FIG. 2 is a schematic view of a portion of the turbine section 28 of the gas turbine engine 20 that may employ various embodiments disclosed herein. Turbine section 28 includes an outer support member 60, an inner support member 62, a vane assembly 64, and a seal retainer 66.

The outer support member 60 and inner support member 62 are provided as part of a case assembly that may extend about the turbine section 28. The case assembly may include an outer case that is disposed radially outboard of a radially inboard inner case. The outer support member 60 may be a portion of the outer case and the inner support member 62 may be a portion of the inner case.

The outer support member 60 may be commonly referred to as an outer support ring. The outer support member 60 includes a first mounting feature 70 and a second mounting feature 72. The first mounting feature 70 extends from a portion of the outer support member 60 radially towards the engine central longitudinal axis A. The first mounting feature 70 may be configured as a flange having a substantially flat mounting surface 74 and a first axial opening 76 extending through the substantially flat mounting surface 74. The first mounting feature 70 is disposed axially aft of the most forward portion of the vane assembly 64.

The second mounting feature 72 is axially spaced apart from the first mounting feature 70. The second mounting feature 72 defines a second axial opening 78 that extends axially from a forward face 80 of the second mounting feature 72 towards an aft face 82 of the second mounting feature 72. The aft face 82 is disposed axially forward of the most rearward portion of the vane assembly 64.

The inner support member 62 may be commonly referred to as an inner support ring. The inner support member 62 is radially spaced apart from the outer support member 60 such that the inner support member 62 is disposed radially closer to the engine central longitudinal axis A.

Referring to FIGS. 2 and 3, the inner support member 62 includes an inner support member body 90. The inner support member body 90 includes a first support surface 92, a second support surface 94, a third support surface 96, a fourth support surface 98, and a fifth support surface 100. The first support surface 92 is disposed substantially parallel to the mounting surface 74 of the first mounting feature 70. The first support surface 92 extends radially towards the second support surface 94.

A chamfer 102 may extend between the first support surface 92 and the second support surface 94. The second support surface 94 is disposed substantially parallel to the engine central longitudinal axis A and axially extends between the third support surface 96 and at least one of the chamfer 102 and the first support surface 92.

The third support surface 96 is disposed substantially transverse to the engine central longitudinal axis A. The third support surface 96 radially extends between the second support surface 94 and the fourth support surface 98.

The fourth support surface 98 is disposed substantially parallel to the engine central longitudinal axis A. The fourth support surface 98 axially extends between the third support surface 96 and the fifth support surface 100.

The fifth support surface 100 is disposed substantially transverse to the engine central longitudinal axis A. The fifth support surface 100 radially extends from the fourth support surface 98 towards a platform of the vane assembly 64.

A recess 104 is defined by the fourth support surface 98 proximate an intersection between the fourth support surface 98 and the fifth support surface 100. The recess 104 extends from the fourth support surface 98 towards the engine central longitudinal axis A.

With continued reference to FIGS. 2 and 3, the vane assembly 64 extends between and is supported between the outer support member 60 and the inner support member 62. The vane assembly 64 includes an outer platform 110, an inner platform 112, and a vane 114.

The outer platform 110 is disposed proximate the outer support member 60. The outer platform 110 includes a first outer flange 120 and a second outer flange 122. The first outer flange 120 radially extends towards and abuts the mounting surface 74 of the first mounting feature 70 of the outer support member 60. The first outer flange 120 is operatively coupled to the first mounting feature 70 by a fastener that extends through the first outer flange 120 and extends into the first axial opening 76.

The second outer flange 122 is axially spaced apart from the first outer flange 120 and radially extends towards the outer support member 60. The second outer flange 122 is provided with a hook 124 that is received within the second axial opening 78 of the second mounting feature 72 of the outer support member 60 to operatively connect the second outer flange 122 to the outer support member 60.

Referring to FIGS. 2 and 3, the inner platform 112 is disposed proximate the inner support member 62. The inner platform 112 includes an inner flange 130 that extends towards and at least partially extends into the inner support member 62. The inner flange 130 is disposed proximate and actually aft portion of the inner platform 112. The inner flange 130 is disposed axially forward of the second mounting feature 72 of the outer support member 60. In at least one embodiment, a portion of the inner flange 130 may extend at least partially into the recess 104 defined by the fourth support surface 98 of the inner support member 62.

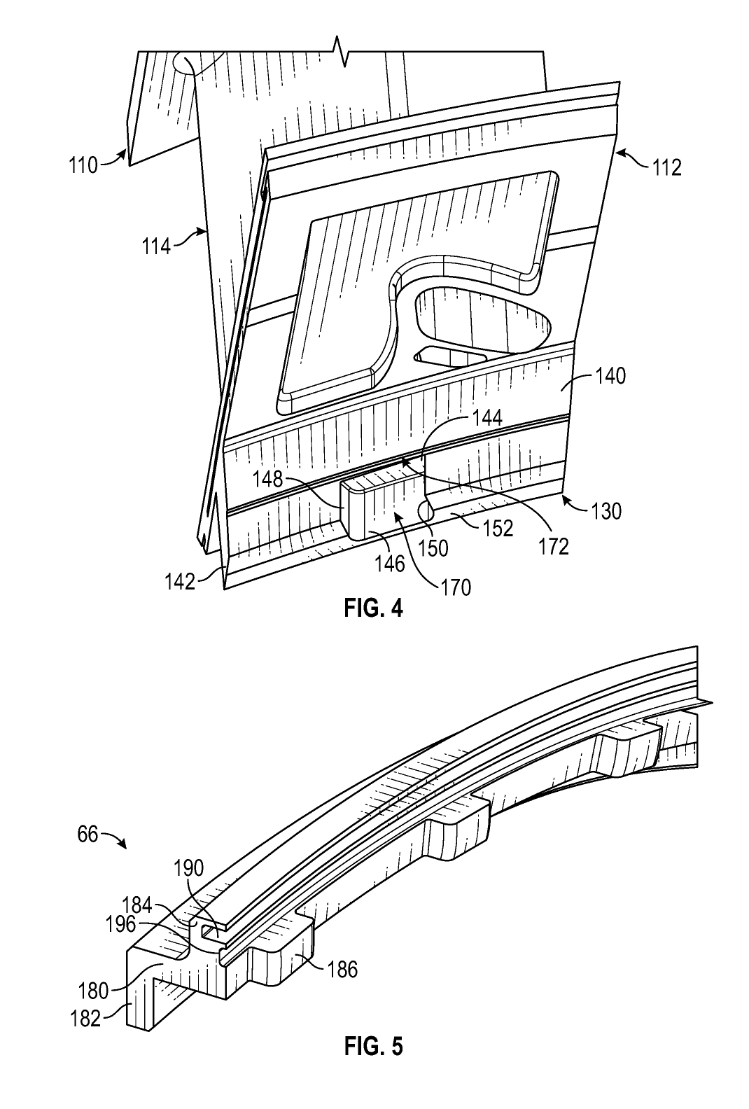

Referring to FIGS. 3 and 4, the inner flange 130 includes a first face 140, a second face 142, a third face 144, a fourth face 146, a first side surface 148, a second side surface 150, and a tip 152.

The first face 140 radially extends from the inner platform 112 towards the engine central longitudinal axis A. The second face 142 is disposed opposite the first face 140. The second face 142 is disposed substantially parallel to the fifth support surface 100 of the inner support member 62. The second face 142 engages the fifth support surface 100 of the inner support member 62 via a chordal seal 160 that axially extends from the second face 142 towards and engages the fifth support surface 100 of the inner support member 62. In at least one embodiment, the inner flange 130 defines a port 154 that extends from the first face 140 to the second face 142.

The third face 144 axially extends from the first face 140 towards the second face 142. The third face 144 is disposed substantially parallel to the fourth support surface 98 of the inner support member 62. The fourth face 146 radially extends from the third face 144 towards the tip 152. The fourth face 146 is disposed substantially parallel to but not coplanar with the first face 140. The fourth face 146 tangentially extends between the first side surface 148 and the second side surface 150.

The first side surface 148 extends between the first face 140, the third face 144, and the fourth face 146. The second side surface 150 is disposed opposite the first side surface 148. The second side surface 150 extends between the first face 140, the third face 144, and the fourth face 146.

The inner flange 130 defines a first notch 170 and the second notch 172. The first notch 170 is disposed proximate the tip 152 of the inner flange 130. The first notch 170 extends from the first face 140 towards the second face 142. The first notch 170 is at least partially defined by the third face 144, the fourth face 146, the first side surface 148, and the second side surface 150. In at least one embodiment, the first notch 170 is a through slot that extends from the first face 140 to the second face 142.

The second notch 172 is axially and radially spaced apart from the first notch 170 such that the second notch 172 is disposed radially outboard of the first notch 170. The second notch 172 is defined between the first face 140 and the third face 144.

The vane 114 axially extends between the outer platform 110 and the inner platform 112. Gas flow over the vane 114 may apply a tangential gas load to the vane assembly 64. The inner flange 130 having the first notch 170 aids in simply supporting the vane assembly to aid in the tangential load transfer to the inner flange 130 to reduce loads on at least one of the first mounting feature 70 and the second mounting feature 72. The seal retainer 66 is provided to meet to the inner support member 62 and the inner flange 130 to provide a circumferential restraint to the vane assembly 64.

Referring to FIGS. 2, 3, and 5, the seal retainer 66 is operatively connected to the inner support member 62 and the inner flange 130 of the inner platform 112 of the vane assembly 64. The seal retainer 66 may be a segmented ring that is disposed about the inner support member 62. The seal retainer 66 is disposed radially between the inner platform 112 and portions of the inner support member 62. The seal retainer 66 includes a seal body 180, a seal flange 182, a seal mounting feature 184, and a lug 186.

The seal body 180 is disposed on the fourth support surface 98 of the inner support member 62. The seal flange 182 radially extends from an axially forward portion of the seal body 180 towards the second support surface 94 of the inner support member 62. The seal flange 182 extends from the seal body 180 in a first direction. The seal flange 182 is disposed substantially perpendicular to the seal body 180. In at least one embodiment, the seal flange 182 engages the third support surface 96 of the inner support member 62. The seal flange 182 is operatively connected to the inner support member 62 by a fastener that extends through the seal flange 182 and extends through the third support surface 96.

The seal mounting feature 184 radially extends from an axially aft portion of the seal body 180 towards the inner platform 112. The seal mounting feature 184 is disposed opposite the seal flange 182. The seal mounting feature 184 extends from the seal body 180 in a second direction that is disposed opposite the first direction. The seal mounting feature 184 is disposed generally parallel to the inner flange 130.

The seal mounting feature 184 defines an opening 190. The opening 190 is an axially extending opening that extends from an axially aft portion of the seal mounting feature 184 towards an axially forward portion of the seal mounting feature 184. The opening 190 is arranged to receive a sealing member 192 that engages the first face 140 of the inner flange 130.

The lug 186 axially extends from an axially aft portion of the seal body 180 towards the inner flange 130. The lug 186 is radially spaced apart from the seal mounting feature 184 by a notched region 196. The lug 186 at least partially extends over the recess 104 of the inner support member 62. The lug 186 extends in a third direction that is disposed transverse to the first direction and the second direction.

The lug 186 is at least partially received by the first notch 170. The lug 186 engages the fourth face 146 of the inner flange 130. In embodiments where the first notch 170 is a through slot, the lug 186 extends through the first notch and 170 and may engage at least one of the first side surface 148 and the second side surface 150. The lug 186 may mate with the first notch 170 of the inner flange 130 to provide circumferential restraint and an anti-rotation feature for the vane assembly 64.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A gas turbine engine, comprising:
an outer support member;
an inner support member radially spaced apart from the outer support member; and
a vane assembly, comprising:
an outer platform having a first outer flange operatively connected to the outer support member,
an inner platform having an inner flange, the inner flange having a first face, a second face disposed opposite the first face, a third face extending from the first face towards the second face, and a fourth face extending from the third face towards a tip of the inner flange, the third face and the fourth face at least partially defining a first notch, and
a vane extending between the outer platform and the inner platform.

2. The gas turbine engine of claim 1, wherein the inner flange has a first side surface that extends between the first face, the third face, and the fourth face and the inner flange has a second side surface that is disposed opposite the first side surface and that extends between the first face, the third face, and the fourth face.

3. The gas turbine engine of claim 2, wherein the first notch is further defined by the first side surface and the second side surface.

4. The gas turbine engine of claim 2, wherein the second face engages the inner support member.

5. The gas turbine engine of claim 2, wherein the first outer flange abuts the outer support member.

6. The gas turbine engine of claim 2, further comprising:
a seal retainer that is operatively connected to the inner platform and engages the inner flange.

7. The gas turbine engine of claim 6, wherein the seal retainer includes a seal body, a lug extending from the seal body and is at least partially received by the first notch, and a seal flange extending from the seal body and is disposed perpendicular to the seal body.

8. A vane assembly for a gas turbine engine, comprising:
an outer platform;
an inner platform disposed opposite the outer platform, the inner platform including an inner flange that extends from the inner platform towards an inner support member, the inner flange having a first face and a second face disposed opposite the first face, the inner flange defining a first notch that extends from the first face towards the second face;
a vane extending between the outer platform and the inner platform; and
a seal retainer has a seal body, a lug extending from the seal body and is at least partially received within the first notch, and a seal flange extending from the seal body and extending towards the inner platform.

9. The vane assembly of claim 8, wherein the inner flange has a third face extending from the first face towards the second face, a fourth face extending from the third face towards a tip of the inner flange, a first side surface that extends between the first face, the third face, and the fourth face and the inner flange has a second side surface that is disposed opposite the first side surface and that extends between the first face, the third face, and the fourth face.

10. The vane assembly of claim 9, wherein the first notch is defined by the third face, the fourth face, first side surface, and the second side surface of the inner flange.

11. The vane assembly of claim 9, wherein the first notch is disposed proximate the tip of the inner flange.

12. The vane assembly of claim 9, wherein the seal body is disposed on the inner support member and the seal flange is operatively connected to the inner support member.

13. The vane assembly of claim 12, wherein the seal retainer has a seal mounting feature extending from the seal body and is disposed opposite the seal flange.

14. The vane assembly of claim 13, wherein the seal mounting feature defines an opening that is arranged to receive a sealing member that engages the first face.

15. The vane assembly of claim 14, wherein the lug engages the fourth face.

16. A vane assembly, comprising:
an inner platform disposed opposite an outer platform and provided with an inner flange having a first face, a second face disposed opposite the first face, a third face extending from the first face towards the second face, a fourth face extending from the third face towards a tip of the inner flange, a first side surface and a second side surface disposed opposite the first side surface, each extending between the first face, the third face, and the fourth face, wherein the third face, the fourth face, the first side surface, and the second side surface defining a first notch;
a vane extending between the outer platform and the inner platform; and
a seal retainer has a seal body and a lug extending from the seal body and received by the first notch.

17. The vane assembly of claim 16, wherein the seal retainer has a seal flange extending from the seal body that is operatively connected to an inner support member.

18. The vane assembly of claim 17, wherein the seal flange extends from the seal body in a first direction.

19. The vane assembly of claim 18, wherein the lug extends from seal body in a direction that is disposed transverse to the first direction.
